(19) United States
(12) Patent Application Publication
(10) Pub. No.: US 2005/0140882 A1
(43) Pub. Date: Jun. 30, 2005

(54) Liquid crystal display device having compensation film and fabrication method thereof

(75) Inventor: Su Hyun Park, Anyang-si (KR)

Correspondence Address: MORGAN LEWIS & BOCKIUS LLP, 1111 PENNSYLVANIA AVENUE NW, WASHINGTON, DC, 20004, US

(73) Assignee: LG.PHILIPS LCD CO., LTD.

(21) Appl. No.: 10/878,534

(22) Filed: Jun. 29, 2004

(30) Foreign Application Priority Data
Dec. 30, 2003 (KR) 100137/2003

(51) Int. Cl. G02F 1/1335

(52) U.S. Cl. 349/119

(57) ABSTRACT

A liquid crystal display device includes an upper substrate; a lower substrate separated from the upper substrate; a liquid crystal layer between the upper substrate and the lower substrate; a first polarizing plate on a surface of the upper substrate; a second polarizing plate on a surface of the lower substrate such that a first optical axis of the first polarizing plate is substantially perpendicular to a second optical axis of the second polarizing plate; a first compensation film on an inner surface of the upper substrate and including a retarder material coating, the first compensation film being provided for compensating for anisotropic distribution and aligning liquid crystal material of the liquid crystal layer; and a second compensation film on an inner surface of the lower substrate and including retarder material coating, the second compensation film being provided for compensating for anisotropic distribution and aligning liquid crystal material of the liquid crystal layer.

This application claims the benefit of Korean Patent Application No. 100137/2003 filed in Korea on Dec. 30, 2003, which is hereby incorporated by reference.

### BACKGROUND OF THE INVENITON

1. Field of the Invention

The present invention relates to a liquid crystal display device and fabrication method thereof, and more particularly, to a liquid crystal display device having a compensation film and a fabrication method thereof.

2. Description of the Related Art

As well known in the art, liquid crystal (LC) molecules have an anisotropy, and the anisotropy of an LC cell having such LC molecules or a film changes according to a distribution and a tilt angle of liquid crystal molecules. Due to the anisotropy of the liquid crystal molecules, the polarization of light with respect to the LC cell or the film changes according to a viewing angle. Due to the inherent characteristics of the LC, variations in the ratios of the brightness and the contrast according to upper, lower, left and right viewing angles are caused during an operation of a liquid crystal display device (LCD). These variations are often the greatest disadvantage of the LCD.

To overcome the foregoing problems, a compensation film has been proposed for compensating for anisotropic distribution according to the viewing angle of the liquid crystal cell. The compensation film, being made of a polymer film, causes a change in a phase difference of a transmitted light. Also, the compensation film is extended in a predetermined direction to cause birefringence due to anisotropic induction of the molecules.

In more detail, when an external electric field is applied to a normal black mode twisted nematic (TN) LCD, liquid crystal molecules are aligned in response to the electric field, so that a light transmission is generated according to the equations below:

$$\begin{matrix}I = {I}_{0} {sin}^{2} [ θ {( 1 + {u}^{2} )}^{1 / 2 } ] , \\ u = \frac{π R}{θ λ} , and \\ R = Δ n \cdot d\end{matrix}$$

where I is intensity of a transmission light, I₀ is an intensity of an incident light, Δn is a birefringence, d is a thickness of an LC cell, λ is a wavelength of the transmission light, θ is a twist angle of a twisted nematic LC, and R is a phase difference.

As will be seen from the above equations, since the phase difference has a close relationship with the viewing angle, a compensation of the phase difference is desirable to improve the viewing angle. The compensation films disposed between the LCD panel and the polarizing plate compensate for phase difference using a uniaxial birefringence anisotropic material and a biaxial birefringence anisotropic material.

FIGS. 1A through 1C show a refractive anisotropic ellipsoid of a phase difference compensation film. As shown in FIGS. 1A through 1C, when assuming that refractive indexes in x, y, z-direction of a Cartesian coordinate are nₓ, n_{y} and n_{z}, the uniaxial property and the biaxial property are determined by sizes of nₓ and n_{y}. In other words, as shown in FIG. 1A, when refractive indexes in two directions are identical to each other but different than the refractive index in the remaining direction, it is called ‘uniaxial property’. The commonly used compensation film using a uniaxial refractive index anisotropic material has a long axis of an ellipsoid, which is parallel to or perpendicular to a surface of a film. The compensation film may be manufactured by extending a polymer film uniaxially or biaxially to obtain a desired birefringence such that an optical axis of the phase difference film has an arbitrary angle with respect to an advancing direction of the film.

Meanwhile, instead of attaching the compensation film manufactured by the extending method, a method in which a compensation film is directly coated on a substrate has been proposed. FIG. 2 is a schematic view of an LCD provided with a compensation film coating according to the related art.

As shown in FIG. 2, an LCD 1 having a compensation film coating includes an upper substrate 20 provided with a color filter layer 22 formed thereon, and a lower substrate 10 provided with thin film transistors 12 formed thereon. The upper substrate 20 is spaced apart by a predetermined distance from the lower substrate 10, and a liquid crystal layer 30 is disposed between the upper substrate 20 and the lower substrate 10. First and second polarizing plates 21 and 11 are respectively disposed on outer surfaces of the upper substrate 20 and the lower substrate 10. First and second compensation films 23 and 13 are respectively coated on outer surfaces of the upper substrate 20 and the lower substrate 10. The LCD 1 further includes a first alignment film 24 formed on the first compensation film 23 for initially aligning liquid crystal molecules of the liquid crystal layer 30, and a second alignment film formed on the second compensation film 13 for initially aligning liquid crystal molecules of the liquid crystal layer 30. The first and second compensation films 23 and 13 are formed by coating a retarder material.

In more detail, to form the first and second compensation films 23 and 13, an alignment film is first formed and then subjected to an alignment treatment process, thereby allowing an optical axis of the compensation films to have an arbitrary angle. After that, a curable liquid crystal having a retarder material coating is coated on the alignment-treated alignment film. The curable liquid crystal is cured using ultraviolet rays to be adhered as a film on each of the substrates.

In the above described configuration, an alignment film is formed on the upper substrate and the lower substrate prepared as above. In other words, performance characteristics of the LCD such as light transmittance, response speed, viewing angle, and a contrast are determined according to alignment characteristics of liquid crystal molecules. Hence, it is very important to uniformly control the alignment of the liquid crystal molecules. The uniform alignment of the liquid crystal molecules cannot be obtained only by interposing the liquid crystal layer between the upper substrate and the lower substrate. To this end, the alignment film is formed on the upper and lower substrates. The alignment film can be formed by printing an organic polymer such as polyimide or polyamide and then curing the printed organic polymer. The cured alignment film is aligned in a predetermined direction by a rubbing method where the alignment film is aligned using a special rubbing cloth, an ion beam, or a photo-alignment.

However, when the LCD is formed using the compensation film coating, the process of forming the compensation film coating and the process of forming the alignment film for alignment of liquid crystal molecules are respectively performed, thereby increasing the number of processes used and resultantly decreasing the yield.

### SUMMARY OF THE INVENTION

Accordingly, the present invention is directed to a liquid crystal display device having a compensation film coating and fabrication method thereof that substantially obviates one or more problems due to limitations and disadvantages of the related art.

An object of the present invention is to provide a liquid crystal display device having a compensation film and a fabrication method thereof, in which the compensation film is formed of a material having both functions of the compensation film and an alignment film.

Another object is to provide a liquid crystal display device fabricated by fewer processes, with improved yield, and superior performance.

Additional features and advantages of the invention will be set forth in the description which follows, and in part will be apparent from the description, or may be learned from practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described herein, a liquid crystal display device, comprises an upper substrate; a lower substrate separated from the upper substrate; a liquid crystal layer disposed between the upper substrate and the lower substrate; a first polarizing plate disposed on a surface of the upper substrate; a second polarizing plate disposed on a surface of the lower substrate such that a first optical axis of the first polarizing plate is substantially perpendicular to a second optical axis of the second polarizing plate; a first compensation film disposed on an inner surface of the upper substrate and including a retarder material coating, the first compensation film being provided for compensating for anisotropic distribution and aligning liquid crystal material of the liquid crystal layer; and a second compensation film disposed on an inner surface of the lower substrate and including retarder material coating, the second compensation film being provided for compensating for anisotropic distribution and aligning liquid crystal material of the liquid crystal layer.

In another aspect, a method of fabricating a liquid crystal display device comprises forming an alignment film on a substrate; curing the formed alignment film; performing an alignment treatment of the alignment film; coating a liquid crystal material including reactive mesogen on the alignment-treated alignment film; and performing an alignment treatment of the coated liquid crystal material.

In another aspect, a liquid crystal display device comprises an upper substrate; a lower substrate; a liquid crystal layer disposed between the upper substrate and the lower substrate; a first compensation film disposed on the upper substrate, the first compensation film for compensating for anisotropic distribution and aligning liquid crystal material of the liquid crystal layer; and a second compensation film disposed on the lower substrate and material, the second compensation film for compensating for anisotropic distribution and aligning liquid crystal material of the liquid crystal layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIGS. 1A to 1C are views showing refractive index anisotropic ellipsoids of a phase-difference compensation film;

FIG. 2 is a view schematically showing a structure of an LCD with a related art compensation film;

FIG. 3 is a view schematically showing a structure of an exemplary LCD having a compensation film coating according to the present invention;

FIGS. 4A through 4D are flow diagrams illustrating a method of fabricating an exemplary LCD having a compensation film according to an exemplary configuration the present invention; and

FIG. 5 is a view illustrating characteristics of a reactive mesogen used as a retarder coating.

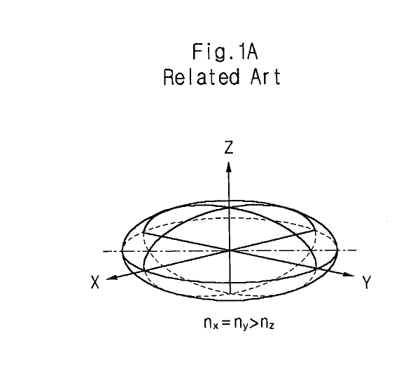

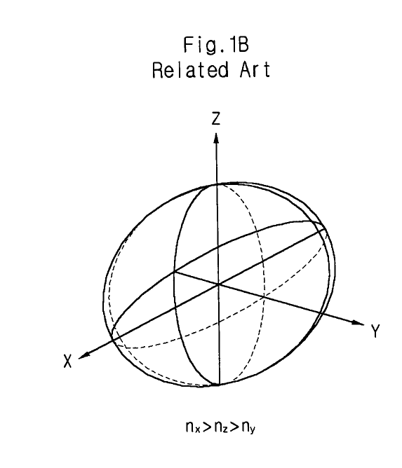

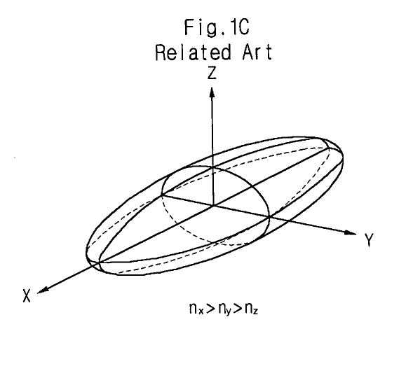

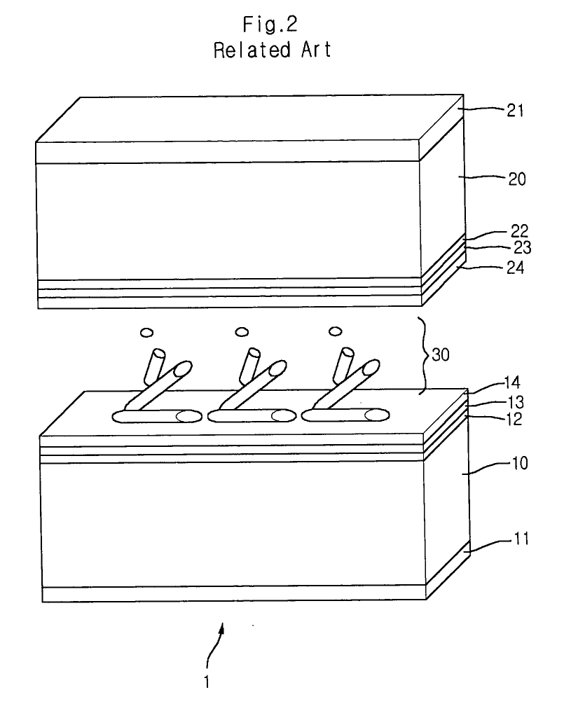

### DETAILED DESCRIPTION OF THE PREFERRED EMBODIMENTS

Reference will now be made in detail to the preferred embodiments of the present invention, examples of which are illustrated in the accompanying drawings.

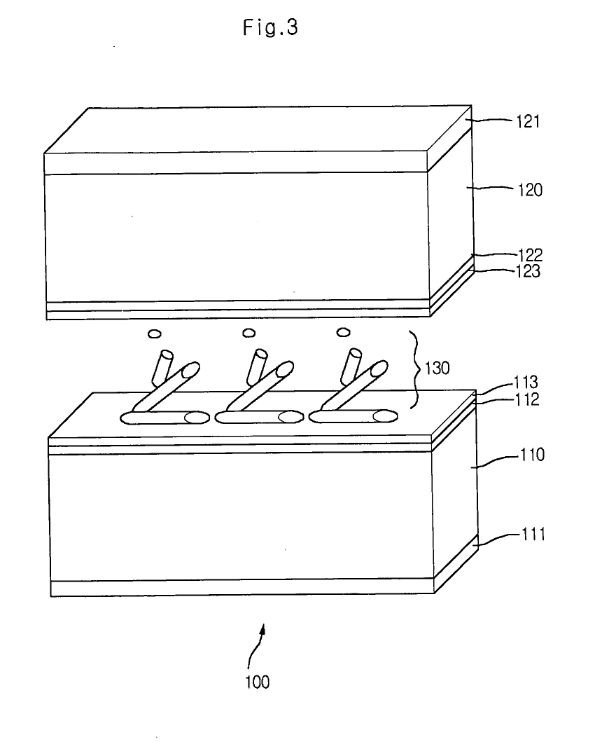

FIG. 3 is a view schematically showing a construction of a liquid crystal display device having a compensation film coating according to an embodiment of the present invention.

As shown in FIG. 3, a liquid crystal display device 100 according to an exemplary configuration of the invention includes an upper substrate 120 having a color filter array 122 formed thereon, and a lower substrate 110 having a thin film transistor array 112 formed thereon. The upper substrate 120 is spaced apart by a predetermined distance from the lower substrate 110, and a liquid crystal layer 130 interposed between the upper substrate 120 and the lower substrate 110. First and second polarizing plates 121 and 111 are respectively disposed on outer surfaces of the upper substrate 120 and the lower substrate 110. A first optical axis of the first polarizing plate 121 is perpendicular to a second optical axis of the second polarizing plate 111. The LCD 100 further includes first and second compensation films 123 and 113. The first compensation film 123 is coated on an inner surface of the upper substrate 120 and functions as an alignment film. The second compensation film is coated on an inner surface of the lower substrate 110 and functions as an alignment film.

In the thin film transistor array 112, a plurality of thin film transistors, each functioning as a switching element, and a plurality of pixel electrodes are formed on the lower substrate 110. Each of the plurality of thin film transistors is formed at a cross point of a gate bus line and a data bus line. In the color filter array 112 of the upper substrate 120, a black matrix (BM) layer, a color filter layer and a common electrode layer are sequentially formed. Optionally, an overcoat layer may be further formed between the color filter layer and the common electrode layer.

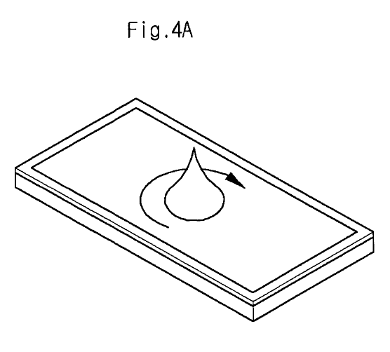

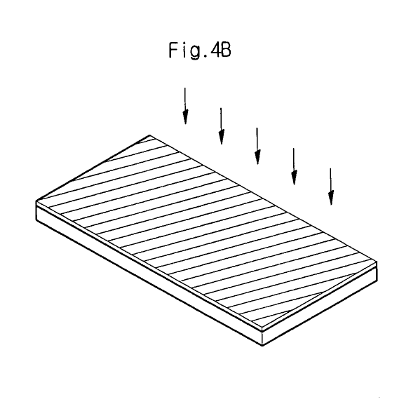

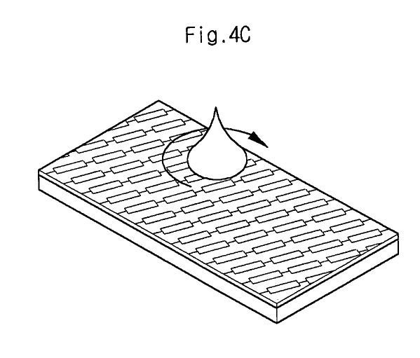

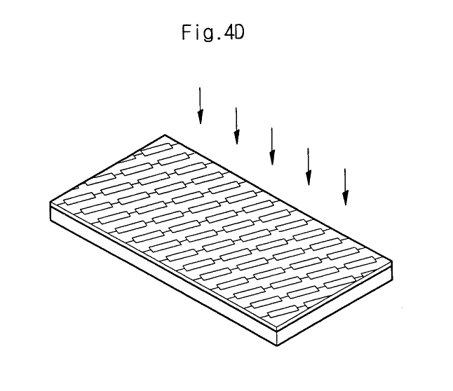

Next, a method of fabricating an exemplary LCD having a compensation film coating will be described with reference to FIGS. 4A through 4D. FIGS. 4A through 4D are flow diagrams illustrating a method of fabricating an LCD having a compensation film according to an exemplary configuration the present invention.

First, as shown in FIG. 4A, an organic polymer material called ‘alignment film’ is formed on the upper substrate 120 having the color filter layer formed thereon, or on the lower substrate 110 having the thin film transistors formed thereon to align the liquid crystal molecules. The coated organic polymer material is preferably kept at a temperature range of 60-80° C. such that a solvent contained in the organic polymer material is vaporized. After that, the organic polymer material is cured at a temperature range of 80-200° C. The alignment film may be a polyimide-based organic material.

Next, as shown in FIG. 4B, the cured alignment film is alignment-treated by irradiating polarized or unpolarized ultraviolet rays or an ion beam onto the alignment film. At this time, by variably adjusting an alignment direction of the alignment film, an optical axis of a compensation film being formed later may have a predetermined angle with respect to an advancing direction of the film. Alternatively, the alignment film may be aligned by a rubbing method.

Next, as shown in FIG. 4C, a retarder film coating including reactive mesogen is coated on the alignment-treated alignment film.

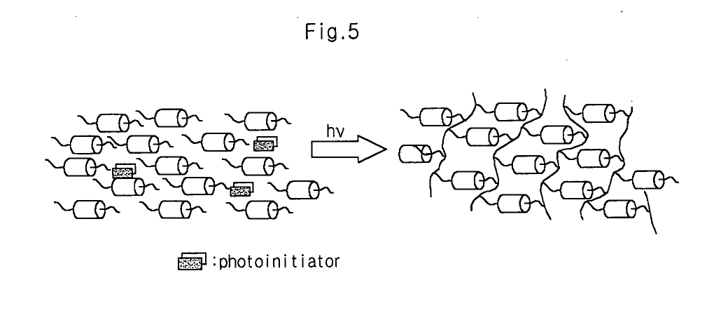

FIG. 5 is a view for illustrating characteristics of reactive mesogen used as a retarder coating. As shown in FIG. 5, since the reactor coating including reactive mesogen has liquid crystal properties as well as linear properties, the reactive mesogen tends to align in one direction. As polymers including the reactive mesogen having the properties of liquid crystal, there are, for example, main chain type and side chain type where conjugated linear atomic group (mesogen) providing the alignment property of liquid crystal is introduced into main chains and side chains.

The main chain type liquid crystalline polymer specifically includes a polymer where mesogen radical is bonded to a spacer part providing a flexibility, for example, a polyester-based liquid crystalline polymer having a nematic or smectic alignment property, a discotic polymer, a cholesteric polymer and the like. The side chain type liquid crystalline polymer specifically includes a polymer having polysiloxane, polyacrylate, polymetacrylate or polymalonate as a main chain structure, or a polymer having mesogen providing a nematic or smectic alignment property in which a spacer part having a conjugated atomic group as a side-chain is interposed.

Next, as shown in FIG. 4D, the reactive mesogen coated on the substrate is cured by ultraviolet rays and, thus, is adhered as a film on the substrate. Afterwards, the adhered reactive mesogen film is alignment-treated by irradiating it with polarization or unpolarization UV rays. The irradiation direction and angle of the polarization or unpolarization UV rays are determined depending on a calculated birefringence of liquid crystal molecules, thereby also determining an alignment of the liquid crystal material.

If liquid crystal molecules are aligned in an identical direction to an alignment direction of the alignment film, the compensation film has an identical refractive index distribution to that of the liquid crystal molecules. Accordingly, if a birefringence (Δn) of the liquid crystal molecules is 0.133, a birefringence (Δn) of the fabricated compensation film is 0.133, which is equal to the birefringence of the liquid crystal molecules.

Retardation is varied with a thickness of the liquid crystal film. When the liquid crystal film is coated at a thickness of 0.8-1.5 μm, it becomes a λ/4 phase-difference film acting in a visible light range. Accordingly, the retardation of the phase-difference film where the coating thickness of the nematic liquid crystal is controlled in a range from 50 to 400 nm.

Meanwhile, the retarder coating including the cured reactive mesogen may be alignment-treated by a rubbing method, and non-rubbing methods such as an ion beam method, a photo-rubbing method, a plasma rubbing method, etc. Thus, the retarder layer formed using the reactive mesogen functions as an alignment film for aligning the liquid crystal molecules as well as a compensation film.

As described above, according to an LCD having a cotable compensation film and fabrication method thereof, a material functions as an alignment film for aligning the liquid crystal molecules as well as a compensation film, thereby decreasing the number of the processes.

It will be apparent to those skilled in the art that various modifications and variations can be made in the liquid crystal display having a compensation film coating and fabrication method thereof of the present invention without departing from the spirit or scope of the invention. Thus, it is intended that the present invention cover the modifications and variations of this invention provided they come within the scope of the appended claims and their equivalents.

1. A liquid crystal display device, comprising:
an upper substrate;
a lower substrate separated from the upper substrate;
a liquid crystal layer disposed between the upper substrate and the lower substrate;
a first polarizing plate disposed on a surface of the upper substrate;
a second polarizing plate disposed on a surface of the lower substrate such that a first optical axis of the first polarizing plate is substantially perpendicular to a second optical axis of the second polarizing plate;
a first compensation film disposed on an inner surface of the upper substrate and including a retarder material coating, the first compensation film being provided for compensating for anisotropic distribution and aligning liquid crystal material of the liquid crystal layer; and
a second compensation film disposed on an inner surface of the lower substrate and including retarder material coating, the second compensation film being provided for compensating for anisotropic distribution and aligning liquid crystal material of the liquid crystal layer.

2. The liquid crystal display device of claim 1, wherein the retarder material coating includes reactive mesogen.

3. The liquid crystal display device of claim 2, wherein the reactive mesogen is aligned in one direction by a linearity.

4. The liquid crystal display device of claim 2, wherein the reactive mesogen includes a liquid crystal material.

5. The liquid crystal display device of claim 4, wherein the liquid crystal material is a nematic or smectic liquid crystal.

6. The liquid crystal display device of claim 2, wherein the reactive mesogen includes a curable liquid crystal material having one of a uniaxial property and a biaxial property and containing a curing reactor.

7. The liquid crystal display device of claim 1, wherein the retarder material coating of the first and second compensation films includes reactive mesogen having an alignment treatment to define the alignment of the liquid crystal material.

8. The liquid crystal display device of claim 7, wherein the reactive mesogen is aligned using a rubbing method

9. The liquid crystal display device of claim 7, wherein the reactive mesogen is aligned using one of an ion beam alignment method, a photo-alignment method and a plasma alignment method.

10. A method of fabricating a liquid crystal display device, comprising:
forming an alignment film on a substrate;
curing the formed alignment film;
performing an alignment treatment of the alignment film;
coating a liquid crystal material including reactive mesogen on the alignment-treated alignment film; and
performing an alignment treatment of the coated liquid crystal material.

11. The method of claim 10, further comprising, after coating the liquid crystal material on the alignment-treated alignment film, curing and adhering the coated liquid crystal material.

12. The method of claim 10, wherein the reactive mesogen is aligned using a rubbing method.

13. The method of claim 10, wherein the reactive mesogen is aligned using one of a non-rubbing method including an ion beam alignment method, a photo-alignment method and a plasma alignment method.

14. A liquid crystal display device, comprising:
an upper substrate;
a lower substrate;
a liquid crystal layer disposed between the upper substrate and the lower substrate;
a first compensation film disposed on the upper substrate, the first compensation film for compensating for anisotropic distribution and aligning liquid crystal material of the liquid crystal layer; and
a second compensation film disposed on the lower substrate and material, the second compensation film for compensating for anisotropic distribution and aligning liquid crystal material of the liquid crystal layer.

15. The liquid crystal display device of claim 14, wherein the first and second compensation films include retarder material coatings of reactive mesogen.

16. The liquid crystal display device of claim 15, wherein the reactive mesogen is aligned in one direction by a linearity.

17. The liquid crystal display device of claim 15, wherein the reactive mesogen includes a liquid crystal material.

18. The liquid crystal display device of claim 17, wherein the liquid crystal material is a nematic or smectic liquid crystal.

19. The liquid crystal display device of claim 15, wherein the reactive mesogen includes a curable liquid crystal material having one of a uniaxial property and a biaxial property and containing a curing reactor.

20. The liquid crystal display device of claim 14, wherein the first and second compensation films include a retarder material coating of reactive mesogen having an alignment treatment to define the alignment of the liquid crystal material.

21. The liquid crystal display device of claim 20, wherein the reactive mesogen is aligned using a rubbing method

22. The liquid crystal display device of claim 20, wherein the reactive mesogen is aligned using one of an ion beam alignment method, a photo-alignment method and a plasma alignment method.
